(19) United States
(12) Patent Application Publication
(10) Pub. No.: US 2007/0157307 A1
(43) Pub. Date: Jul. 5, 2007

(54) Secure communication control technique

(75) Inventors: Masafumi Katoh, Kawasaki (JP); Akihiro Inomata, Kawasaki (JP); Shinnosuke Okubo, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/501,350

(22) Filed: Aug. 9, 2006

(30) Foreign Application Priority Data
Jan. 5, 2006 (JP) 2006-000767

(51) Int. Cl. G06F 15/16; G06F 15/173; G06F 17/00; G06F 9/00

(52) U.S. Cl. 726/14; 709/238; 726/15

(57) ABSTRACT

This invention is to improve security in a network. A communication control method for controlling communications in a network including a plurality of secure network devices having one or more predetermined security functions includes: receiving a contents request for specific contents in addition to a destination of the contents request; and carrying out a routing by using, as routing conditions, security functions to be carried out in a transmission path of the specific contents from the destination of the contents request to a source thereof and a quantitative condition of the secure network devices (for example, the number of devices, the ratio of the devices, and the like) having the security functions.

### TECHNICAL FIELD OF THE INVENTION

The present invention relates to a network and a communication technique in consideration of security.

### BACKGROUND OF THE INVENTION

Crimes using a network such as a flood of spam and phishing fraud are really growing as well as computer viruses, and importance has been attached to the information security more and more. In order to cope with such situations, various techniques for the information security appear. For example, a mail server or the like in an Internet service provider (ISP) carries out virus checks for e-mails in one technique. In another technique, the security level of a personal computer (PC) connected to the Intranet is checked in a security center via the network (i.e. Intranet), and if the security level of the PC does not exceed a predetermined level, the PC is inhibited to get connected to the Intranet.

Moreover, JP-A-2003-174483 discloses a technique to reduce the administration workload caused when the security management is carried out according to various requests from the corporate. Specifically, a first routing server retains association information among a data transfer path, conditions of data to be transferred along the data transfer path, and security functions to be carried out. The first routing server 11 determines the data transfer path upon receipt of an access, first. It then notifies the devices on the data transfer path of information concerning the data transfer path, the conditions of the data to be transferred along the data transfer path, and the security functions to be carried out. Upon receipt of the notification, a firewall, a virus detection server, and the like judge whether or not the passage of the data satisfying the conditions should be allowed or conduct the virus check for the data. If there is no problem on the security, they transfer the data along the data transfer path notified in advance. This publication, however, does not mention the number of devices on the data transfer path, but focuses only on setting of the routing. Therefore, no consideration is given to the security of the entire network. In addition, only the security functions are considered in the setting of the routing, without considering the total optimization including the optimization for other conditions nor describing a concrete routing algorithm.

### SUMMARY OF THE INVENTION

As described above, the security on the network is considered from various angles. However, there is no document, which focuses on and resolves the various problems in delivering specific contents from a contents server. Furthermore, there is no document describing algorithms of a concrete path control and/or admission control.

Therefore, an object of the present invention is to provide a new technique for improving the security on the network.

Another object of the present invention is to provide a communication technique for achieving required security functions in consideration of various conditions such as user requests, contents, and whether or not there is an abnormal state.

A communication control method according to a first aspect of the present invention, for controlling communications in a network including a plurality of secure network devices having one or more predetermined security functions, includes: receiving a contents request for specific contents in addition to a destination of the contents request; and carrying out a routing by using, as routing conditions, security functions to be carried out in a transmission path of the specific contents from the destination of the contents request to a source thereof and a quantitative condition of the secure network devices (for example, the number of devices, the ratio of the devices, and the like) having the security functions.

Because not only the security functions, but also the quantitative condition of the secure network devices having the security functions are used as the routing conditions in this manner, a processing relating to the security functions are conducted at appropriate frequencies even if the transmission path is long and there is a need for a large number of hops. Thereby, appropriate security is assured. The quantitative conditions may also be varied dynamically.

In addition, when there are a plurality of subnetworks between the destination and the source of the contents request, the quantitative condition of the secure network devices having the security functions to be carried outmay include a quantitative condition in the subnetworks (for example, the number or ratio of the secure network devices in the subnetworks). Thereby, appropriate security is ensured, when the specific contents are delivered via the plurality of subnetworks.

Furthermore, the secure network device may have at least one of a traceability function for recording history concerning the establishment of a call, connection, path, or session or history concerning the passing of contents or packets; a saving function for saving the transferred contents or packets; a filtering function for controlling discarding or passing of the contents or packets; and a receipt acknowledgement function for notifying the source of the receipt of the transferred contents, as security functions. When one secure network device has more security functions, more options for routing are available.

Moreover, the communication control method may further include: determining a security function to be carried out in the transmission path of the specific contents or a security level for identifying the security function based on at least one of information concerning the source of the contents request (for example, a user request or attribute or a user profile), information concerning the destination (for example, an attribute of a contents provider or the like), and information concerning the specific contents (a contents profile or the like). Thus, the security function to be carried out or the security level for identifying the security function is determined, and the routing is carried out according to the security function or the security level.

Furthermore, the communication control method may further include: giving a header corresponding to the security function to be carried out in the transmission path of the specific contents or the security level for identifying the security function to the specific contents data or packets. The appropriate setting of the header causes a processing relating to the security function to be appropriately carried out in the set transmission path.

In addition, the header may include the security level. In such a case, the communication control method may further include: by the secure network device having the security functions in the transmission path, identifying the security function to be carried out based on the security level included in the header, and judging whether or not the security function the secure network has should be carried out. This is carried out in a situation where the security function to be carried out is separately defined for each of the security levels.

On the other hand, the aforementioned header may include an action label designating the security function to be carried out. In such a case, the communication control method may further include: by the secure network device having the security functions in the transmission path, identifying the security function to be carried out based on the action label included in the header, and determining whether or not the security function the secure network device has should be carried out.

A network according to a second aspect of the present invention, includes a plurality of secure network devices, each having at least one of a traceability function for recording history concerning the establishment of a call, connection, path, or session or history concerning the passing of contents or packets; a saving function for saving the transferred contents or packets; a filtering function for controlling discarding or passing of the contents or packets; and a receipt acknowledgement function for notifying a source of the receipt of the transferred contents as security functions, and wherein the secure network devices are positioned on locations that are calculated based on a traffic demand and the number of hops or a distance and minimizes the resource consumption caused when passing through the secure network devices. This enables an efficient delivery of the contents or the like while carrying out required security functions therefor at a required frequency.

A communication control method according to a third aspect of the present invention, for controlling communications in a network including secure network devices having predetermined security functions, includes: receiving a contents request for specific contents in addition to a destination of the contents request; and determining a security function to be carried out by the secure network device in a transmission path of the specific contents or a security level for identifying the security function based on at least one of a source of the received contents request, the destination thereof, and the specific contents. Thereby, the security function necessary for delivering the specific contents is appropriately identified.

A network device according to a fourth aspect of the present invention includes: a unit that receives data concerning a security function to be carried out in a transmission path of specific contents for a contents request for the specific contents or concerning a security level for identifying the security function from a communication control unit; and a unit that gives a header corresponding to the security function to be carried out in the transmission path of the specific contents or the security level for identifying the security function to the specific contents data or packets. When such a network device is arranged as an edge router in the vicinity of a contents server, appropriate routing is achieved. Incidentally, the network device may be integrated into the contents server.

A network according to a fifth aspect of the present invention includes: a plurality of secure network devices, each having a traceability function for recording history concerning the establishment of a call, connection, path, or session or history concerning the passing of contents or packets; a saving function for saving the transferred contents or packets; a filtering function for controlling discarding or passing of the contents or packets; and a receipt acknowledgement function for notifying a source of the receipt of the transferred contents as security functions, wherein the secure network device is positioned on the boundary between subnetworks in a wide area network. This enables the contents to pass through the secure network devices without special setting for the routing, when the contents are transmitted between the subnetworks in the wide area network, whereby required security is assured.

A secure network device according to a sixth aspect of the present invention includes: at least one of a traceability function for recording history concerning the establishment of a call, connection, path, or session or history concerning the passing of contents or packets; a saving function for saving the transferred contents or packets; a filtering function for controlling discarding or passing of the contents or packets; and a receipt acknowledgement function for notifying a source of the receipt of the transferred contents, as security functions. Furthermore, the secure network device includes: a unit that receives data or a packet of the specific contents, which has a header corresponding to a security function to be carried out in a transmission path of the specific contents for the contents request for the specific content or to a security level for identifying the security function; and a unit that identifies a security function to be carried out based on the security level included in the header if the header includes the security level, and judges whether or not the security function the secure network device has should be carried out.

In addition, the secure network device may include a unit that identifies the security function to be carried out based on an action label included in the header if the header includes the action label designating the security function to be carried out, and judges whether or not the security function the secure network device has should be carried out.

It is possible to create a program for causing a computer to execute the aforementioned communication control method or the like according to the present invention, and this program is stored in a storage medium or a storage device such as a flexible disk, a CD-ROM, an optical magnetic disk, a semiconductor memory, and a hard disk. Further, the program may be distributed as a digital signal through a network. Incidentally, intermediate processing results are temporarily stored in a storage device such as a main memory.

### BRIEF DESCRIPTION OF THE DRAWINGS

FIG. 1 is a diagram showing a system outline of an embodiment of the present invention;

FIG. 2 is a functional block diagram of a secure node;

FIG. 3 is a diagram showing an example of a security policy used at the time of a normal state;

FIG. 4 is a diagram showing a first portion of a processing flow in the embodiment of the present invention;

FIG. 5 is a diagram showing a processing flow of a security determining processing;

FIG. 6 is a diagram showing a processing flow of a confirmation processing;

FIG. 7 is a diagram showing a processing flow of a first routing processing;

FIG. 8 is a diagram showing an outline of the secure routing;

FIG. 9 is a diagram showing a processing flow of a second routing processing;

FIG. 10 is a diagram showing a network outline to explain the second routing processing;

FIG. 11 is a diagram showing a second portion of the processing flow in the embodiment of the present invention;

FIG. 12 is a diagram showing a processing flow of an admission control processing;

FIG. 13 is a diagram showing a third portion of the processing flow in the embodiment of the present invention;

FIG. 14 is a diagram to explain a first example of a header setting processing at the time of the normal state;

FIG. 15 is a diagram to explain a first example of a header setting processing at the time of an abnormal state;

FIG. 16 is a diagram showing an example of the security policy at the time of the abnormal state;

FIG. 17 is a diagram showing a second example of the header setting processing at the time of the normal state;

FIG. 18 is a diagram showing a second example of the header setting processing at the time of the abnormal state;

FIG. 19A is a schematic diagram when the secure node has a single function;

FIG. 19B is a schematic diagram when the secure node has plural functions;

FIGS. 20A and 20B are diagrams to explain consideration on an arrangement of the secure nodes;

FIG. 21 is a diagram to explain consideration on the arrangement of the secure nodes; and

FIG. 22 is a functional block diagram of a computer.

### DETAILED DESCRIPTION OF THE PREFERRED EMBODIMENTS

In the preferred embodiments of the present invention, we introduce a concept “secure or insecure communication path” into a network just like there are secure or insecure roads. More specifically, a path passing through several nodes having a security function is defined as a secure path and the secure path is selected according to a request.

More specifically, when carrying out the routing, the total optimization is achieved by means of an algorithm where the presence or absence of a security function is added as a condition to a general condition of selecting the minimum cost path. Furthermore, even if there is no freedom in the routing, for example, the path has already been determined, the security function can be carried out by checking the presence or absence of the security function in an admission control at path setting.

Moreover, consideration is given to changing a processing between a normal condition and an abnormal condition such as an accident occurrence, and it becomes possible to provide a basic technique for building up a high-reliability infrastructure.

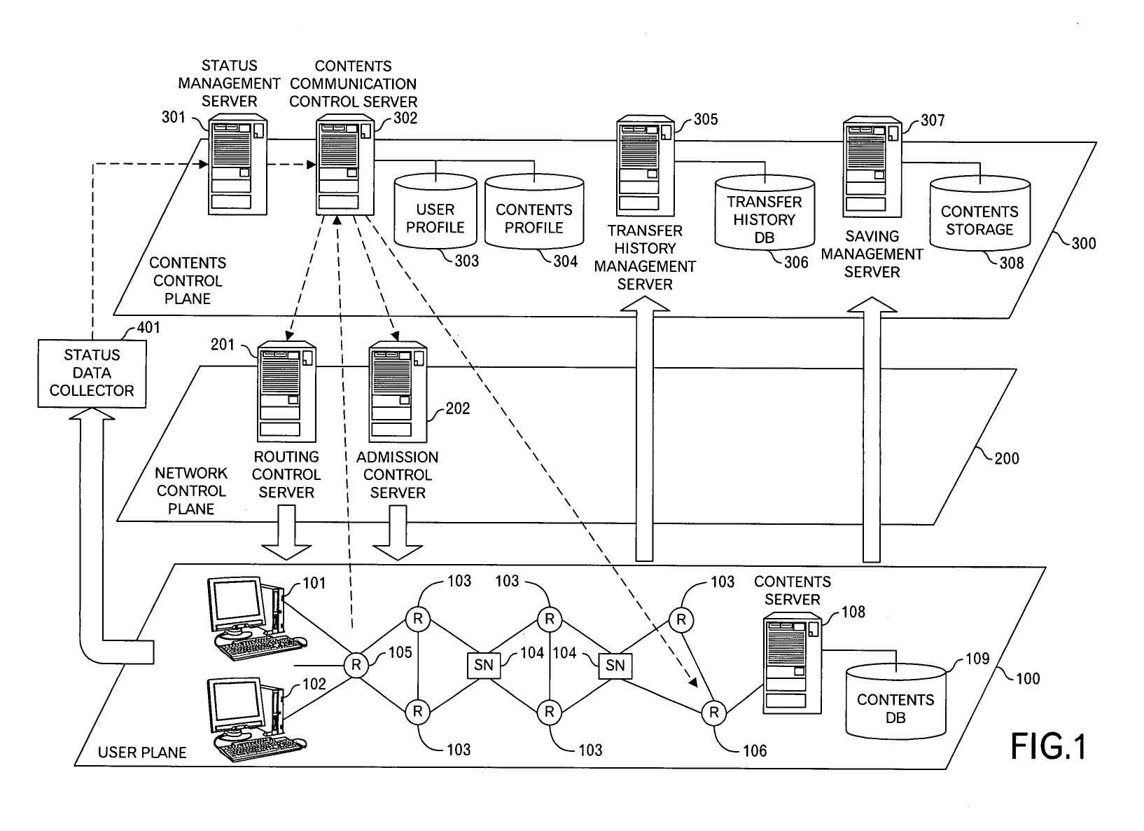

FIG. 1 shows a system schematic diagram in one embodiment of the present invention. The system according to this embodiment is composed of three planes: a user plane 100, a network control plane 200, and a contents control plane 300. The user plane 100 includes various devices connected to a network (local area network (LAN), a home network (HN), a wide area network (WAN) or the like). In the example shown in FIG. 1, an edge router 105 on the user terminal side is connected to user terminals 101 and 102 and also to normal routers 103. In addition, the network includes plural secure nodes (SN) 104 having security functions described below and other normal routers 103. Incidentally, the secure nodes 104 are assumed to lie scattered in the network. Moreover, an edge router 106 on the contents server side is connected to a contents server 108. The contents server 108 manages a contents database 109 that stores data on contents to be delivered. There are a large number of servers, devices, and networks belonging to the user plane 100, though they are not shown in FIG. 1. In addition, the devices belonging to the user plane 100 have a function to cooperate with servers in the network control plane 200 and the contents control plane 300 as described below.

The network control plane 200, which is a layer to carry out a network layer function such as establishing a path or connection between a terminal and a server, includes a routing control server 201 and an admission control server 202. The routing control server 201 carries out a processing for determining a path according to an instruction from the contents control plane 300, and carries out the settings necessary for devices in the user plane 100. Furthermore, the admission control server 202 carries out an admission processing, other processing to set a call, connection, path, or session according to an instruction from the contents control plane 300, and the like to carry out settings necessary for the devices in the user plane 100.

The contents control plane 300, which is a layer to determine a service providing method relating to a contents access or to carry out contents services, includes a status management server 301, a contents communication control server 302 for managing a user profile 303 and a contents profile 304, a transfer history management server 305 for managing a transfer history data base 306, and a saving management server 307 for managing a contents storage 308. The status management server 301 judges whether the current status is normal or abnormal based on status data collected in association with the user plane 100 or the like, and notifies the contents communication control server 302 of the judgment result. The contents communication control server 302 determines a security function to be carried out in a transmission path of the contents based on user settings or attributes of a contents requesting source, which are stored in the user profile 303, a policy of a contents provider and an attribute of requested contents, which are stored in the contents profile 304, and the like, and controls the network control plane 200 and the user plane 100. The transfer history management server 305 collects transfer history data from the secure nodes 104 retaining transfer histories, integrates the transfer history data for each contents, and stores it into the transfer history database 306. The saving management server 307 collects contents from the secure nodes 104 that temporarily store the contents if the storage capacitances of the nodes are limited, and then accumulates the contents in the contents storage 308.

The user profile 303 stores definitions of required security functions previously defined by a user in association with each type of contents, for example. Furthermore, for example, a calling destination designated by the user is registered in order to change the processing at the time of an abnormal state. Incidentally, there is a case of retaining user attribute data used to identify a security function to be carried out.

The contents profile 304 stores definitions of required security functions, for example, for each contents provider (for example, for each domain) or definitions of required security functions for each contents attribute. For example, required security functions may be defined for each class such as “medical care” or “finance” or for each subclass such as “personal medical history”, which is a subordinate concept of “medical care”. When such hierarchical definition is made, the definition for a higher layer is used for a lower layer when there is no definition for the lower layer.

Incidentally, there is a case where the administrator of the contents communication control server 302 previously defines conversion rules of the required security functions, and changes the definitions in the contents profile 304. For example, the required security functions are increased or decreased for contents having specific attributes.

The status management server 301 receives collected status data from a status data collector 401 for collecting data on the user plain 100, data on events that occur in traffic, society, weather, or the like and data on events that occur in registered users. This status data collector 401 is composed of various sensors, and includes various devices such as: (1) system for collecting failure occurrence states, congestion states, virus propagation states and the like on the networks in the user plane 100, (2) system for receiving data concerning operation states from a train operation managing system, and/or an apparatus for collecting operation states by using a combination of an IC tag attached to each train or each shuttle bus, an IC tag reader located at each station and each stop and a timetable, (3) system for collecting vehicle movement states from velocity sensors on roads, (4) system for collecting accident information from a system that provides other traffic information, (5) system for collecting specific types of news (war, disturbance, terrorism, and dissolution of congress) from reliable news sources provided on the Internet and so on, (6) seismographs, (7) devices for collecting specific weather data such as hurricane, snowfall, earthquake and so on from hyetometers, barometers, thermometers, hygrometers, anemometers, a meteorological administration homepage and so on, (8) devices for collecting data concerning fire occurrence states from a fire alarm, a smoke detector, a smell sensor and so on, (9) system for collecting data related to variations of stock prices from a stock market system, (10) system for collecting information concerning whether a registered user's house is invaded, that can be obtained from a home security system, (11) system for collecting state data concerning movement of products or persons from IC tags attached to the products, registered users, and persons associated with the registered users, and IC tag readers located at various places, and detecting possibility of robbery or abduction, (12) system for collecting alarms (alarms concerning occurrences of a crime (such as a threat), a disease (such as a fit), and an injury) generated from alarming portable terminals, and (13) system for collecting measurement results of a body temperature, a pulse, and a blood pressure, and detecting specific diseases.

On the basis of (2), (3) and (4), stops of most transportation system, a huge accident, stops of plural train routes, a huge traffic jam having a predetermined level, a traffic jam having a predetermined second level, a single accident and so on are detected. On the basis of (5) and (9), an outbreak of war, a simultaneous terrorist attack, a sudden fall of stock, dissolution of congress, and the like are detected. On the basis of (6), outbreak of an earthquake having an intensity of more than or equal to six, outbreak of an earthquake having an intensity of 4 to 5, outbreak of an earthquake having an intensity of 3 or less and the like are detected. On the basis of (7) and the like, large hurricanes having a predetermined level, heavy snowfall or rain having a predetermined level, a hot weather satisfying a predetermined criterion and so on are detected. On the basis of (8), a scale of fire is detected. On the basis of (10), (12), (13) and the like, a robber invasion, abduction, a threat, a stalker appearance, a pickpocket appearance, a serious condition, a serious injury, a fit of a chronic disease, an injury, a pollinosis (pollen allergy) and the like are detected.

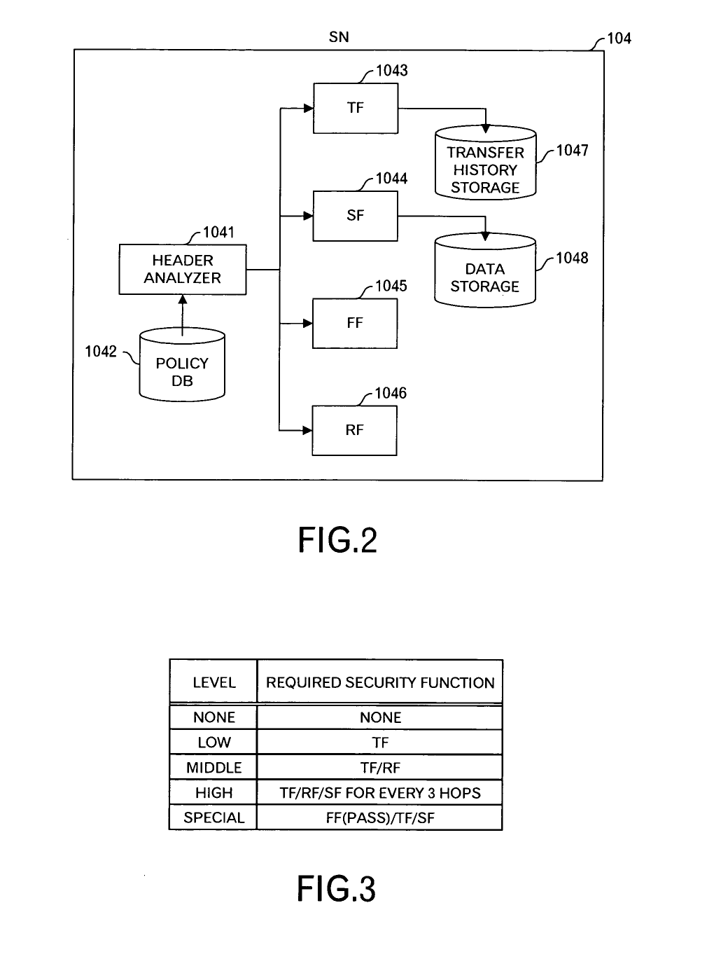

Subsequently, FIG. 2 shows the functional block diagram of the secure node 104. The secure node 104 includes a header analyzer 1041 for interpreting a header appended to contents or packets of the contents to activate a required security function, a policy database 1042 for storing definition data needed when the header analyzer 1041 analyzes the header, and at least one of a traceability function (TF) 1043, a saving function (SF) 1044, a filtering function (FF) 1045, and a receipt acknowledgement function (RF) 1046.

The traceability function 1043 records establishment information on a certain designated call, connection, path, or session, and passage information (including time, source, and destination. Also referred to as transfer history data) of certain designated contents or packets thereof into a transfer history storage 1047. The data stored in the transfer history storage 1047 is deleted by the traceability function 1043 when a certain period of time has passed after it is stored or when a network administrator or the like instructs the deletion. Moreover, the traceability function 1043 transmits the data stored in the transfer history storage 1047 to the transfer history management server 305, for example, at predetermined time intervals. As stated above, upon receiving the transfer history data from the secure nodes 104 each having the traceability function 1043, the transfer history management server 305 sorts out the transfer history data for each contents, and stores them into the transfer history database 306. The transfer history management server 305 extracts transfer history data on required contents data from the transfer history database 306 in response to a request from a user, a network administrator, a contents provider or the like, and provides the user or the like with the transfer history data.

Moreover, the saving function 1044 saves certain designated contents or packets thereof into a data storage 1048. The saving function 1044 deletes the contents or the packets thereof stored in the data storage 1048 after a certain period of time since they were saved, deletes them in order of the saving when the free space of the data storage 1048 is reduced to a predetermined reference level or lower, and/or deletes them in response to an instruction of the user, the network administrator, the contents provider, or the like. In addition, when the saving function 1044 can cooperate with the receipt acknowledgement function 1046, it deletes the saved contents or packets of the contents when it obtains the receipt acknowledgement of the contents or the packets thereof.

The filtering function 1045 is a function to discard or pass certain designated contents or packets thereof. In addition, the receipt acknowledgement function 1046 is a function to notify the source of the receipt completion of the certain designated contents or the packets thereof.

When the security function to be carried out is defined in the header of the received contents or the packets thereof, the header analyzer 1041 only activates a required function according to the header. In some cases, however, the header indicates a security level, for example. In that case, the header analyzer 1041 interprets the header with reference to the policy database 1042. In this regard, data as shown in FIG. 3 is previously stored in the policy database 1042.

In the example shown in FIG. 3, required security functions are defined for respective levels. In this example, the levels are classified into none, low, middle, high, and special. There is no required security function in the level “none”. The traceability function is defined to be carried out in the level “low”. The traceability function and the receipt acknowledgement function are defined to be carried out in the level “middle”. The traceability function, the receipt acknowledgement function, and the saving function are defined to be carried out for every 3 hops in the level “high”. In the level “special”, the filtering function (which passes important contents), traceability function, and the saving function are defined to be carried out for the important contents. In some cases, it may be defined that the frequency of the processing to be carried out increases every time the level is incremented. Specifically, it is also possible to decrease the number of hops, which means the intervals at which the processing is carried out.

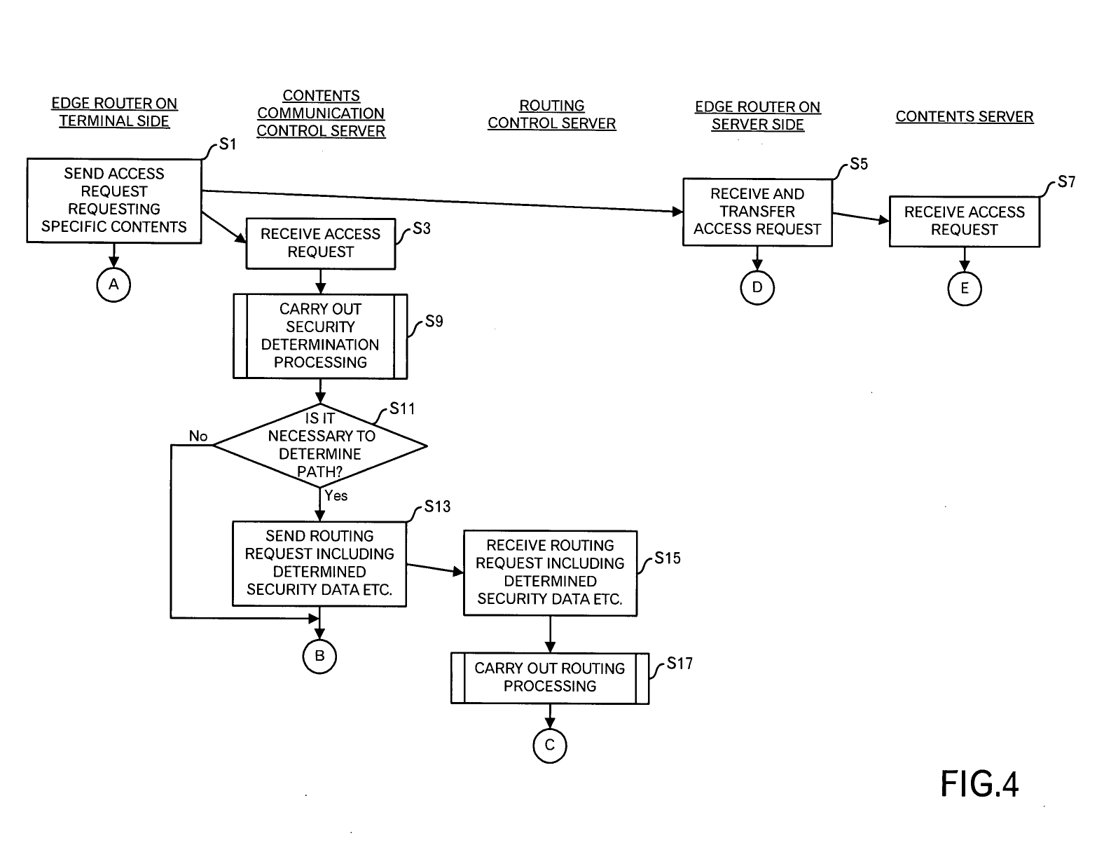

Next, a processing flow of the system shown in FIG. 1 will be described by using FIG. 4 to FIG. 21. For example, the user terminal 101 transmits an access request for requesting specific contents in response to a user's instruction. This access request includes not only data identifying the requested contents such as a uniform resource locator (URL), but also data designating a required security function for the requested contents or data to identify the required security function in response to a user's instruction, depending on circumstances. Furthermore, it may include data concerning a bandwidth necessary or to be ensured for transmitting the requested contents in some instances, though the edge router 105 on the user terminal side may add such data instead of the user terminal 101.

Upon receiving the access request from the user terminal 101, the edge router 105 on the user terminal side transmits the access request to the contents communication control server 302, and transmits the access request to the edge router 106 on the contents server side via the network based on a conventional technique (step S1). The edge router 106 on the contents server side receives the access request from the edge router 105 on the user terminal side, and transfers it to the connected contents server 108 (step S5). The contents server 108 receives the access request from the edge router 106 on the contents server side (step S7). Incidentally, the access request always need not be transmitted to the edge router 106 on the contents server side in this stage, but may be transmitted, for example, after receiving a permission from the contents communication control server 302.

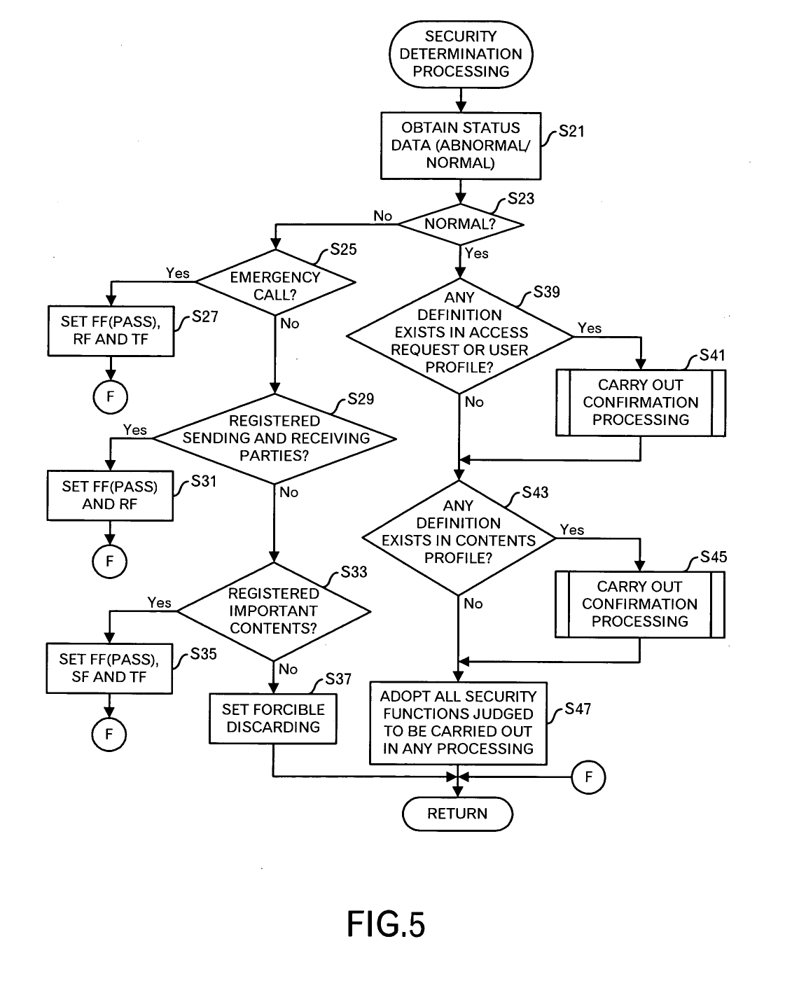

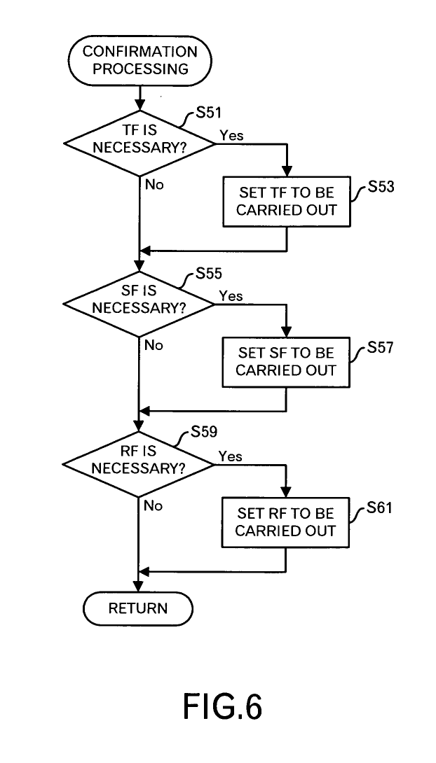

On the other hand, the contents communication control server 302 receives the access request from the edge router 105 on the user terminal side (step S3) and carries out a security determination processing (step S9). The security determination processing will be described with reference to FIG. 5 and FIG. 6.

First, the contents communication control server 302 acquires the current status data (normal or abnormal) from the status management server 301, and stores it into a storage device such as a main memory (step S21). It then judges whether or not the current status is normal based on the status data (step S23). If it is not normal, but abnormal, the contents communication control server 302 judges whether or not the access request is for an emergency call (step S25). For example, the contents communication control server 302 checks whether or not the access request is a connection request (for example, a calling request) to a predetermined emergency callee such as a police station or a fire station.

When it is judged that the access request is for the emergency call, the contents communication control server 302 sets the filtering function (which carries out passing), the receipt acknowledgement function, and the traceability function as required security functions (step S27), and the processing returns to the original processing. In addition, the frequencies of carrying out the required security functions may be set together in some instances.

On the other hand, unless the access request is judged to be for the emergency call, the contents communication control server 302 judges whether or not the source and destination of the access request are registered sending and receiving parties (step S29). For example, it judges whether or not the destination of the access request is previously registered as an incoming call destination in association with the source of the access request on the basis of the data defined in the user profile 303. If the source and destination of the access request are judged to be the registered sending and receiving parties, the contents communication control server 302 sets the filtering function (which carries out passing) and the receipt acknowledge function as required security functions (step S31), and the processing returns to the original processing. Incidentally, the frequencies of carrying out the processing of the required security functions may be set together.

Furthermore, unless the source and destination of the access request are judged to be the registered sending and receiving parties, the contents communication control server 302 judges whether or not the requested contents identified from the access request are registered important contents (step S33). For example, it judges whether or not the requested contents are contents registered as important contents by a contents provider or a user, with reference to the contents profile 304 or the user profile 303. When the requested contents identified from the access request are judged to be the registered important contents, the contents communication control server 302 sets the filtering function (which carries out passing), the saving function, and the traceability function as required security functions (step S35), and the processing returns to the original processing. Incidentally, the frequencies of carrying out the processing of the required security functions may be set together.

Unless the requested contents identified from the access request are judged to be the registered important contents, the contents communication control server 302 sets forcible discarding (step S37). Specifically, it sets the filtering function (which carries out discarding). In this manner, this embodiment causes the contents or packets to always pass through the secure node 104 having the filtering function at the time of an abnormal state, and in a case of an emergency call, a contents request relating to a registered sending and receiving parties, which are supposed in advance, or registered important contents, the contents or packets are allowed to pass through the secure node 104 having the filtering function, and in other cases, it is discarded in the secure node 104 having the filtering function. Thereafter, the control returns to the original processing. It is also possible, however, to progress to step S39. In addition, the combinations of the security functions set in the steps S27, S31, and S35 are mere examples, and therefore the combinations of the security functions may be altered.

In addition, if the current status is judged to be normal in the step S23, the contents communication control server 302 judges whether or not there is any definition of the required security functions in the access request or the user profile 303 (step S39). If it is judged that there is some definition of the required security functions in the access request or the user profile 303, the contents communication control server 302 carries out a confirmation processing for the access request or the user profile 303 (step S41). The confirmation processing will be described with reference to FIG. 6.

In the confirmation processing, the contents communication control server 302 judges whether or not the traceability function is necessary, from a target to be judged (the access request or the user profile 303 in this embodiment) (step S51). For example, it judges whether or not the user requires the traceability function based on whether it is defined in the data of the target to be judged. Specifically, it judges whether or not the necessity of the traceability function is explicitly designated in the access request or whether or not the user registers the necessity of the traceability function in the user profile 303 (or whether or not the necessity of the traceability function is defined by the combination of the user and the requested contents). If the traceability function is judged to be necessary, the contents communication control server 302 sets the traceability function to be carried out (step S53). Incidentally, the frequency of carrying out the processing of the traceability function may be set together.

If the traceability function is judged to be unnecessary in the step S51 or after the step S53, the contents communication control server 302 judges whether or not the saving function is necessary (step S55). Also in this step, the judgment is carried out according to the same criterion of the judgment as described in the step S51. If the saving function is judged to be necessary, the contents communication control server 302 sets the saving function to be carried out (step S57). Incidentally, the frequency of carrying out the processing of the saving function may be set together.

If the saving function is judged to be unnecessary in the step S55 or after the step S57, the contents communication control server 302 judges whether or not the receipt acknowledgement function is necessary (step S59). Also in this step, the judgment is carried out according to the same criterion of the judgment as described in the step S51. If the receipt acknowledgment function is judged to be necessary, the contents communication control server 302 sets the receipt acknowledgment function to be carried out (step S61). Thereafter, if the receipt acknowledgment function is judged to be unnecessary in the step S59 or after the step S61, the control returns to the original processing. Incidentally, the frequency of carrying out the receipt acknowledgment function may be set together.

Returning to the description of FIG. 5, if it is judged that there is no definition of the required security function in the access request or the user profile 303 in the step S39 or after the step S41, the contents communication control server 302 judges whether or not there is any definition of a required security function in the contents profile 304 (step S43) . For example, it judges whether or not there is any definition of a required security function with respect to the contents server 108, which is the destination of the access request, and/or whether or not there is any definition of a required security function corresponding to the contents related to the access request or to the attributes of the contents (identified by URL or the like, for example). If it is judged that there is some definition of the required security function in the contents profile 304, the contents communication control server 302 carries out the confirmation processing for the contents profile 304 (step S45). The confirmation processing is the same as one in FIG. 6, except that the target to be judged is the contents profile 304.

If it is judged that there is no definition of the required security function in the contents profile 304 in the step S43 or after the step S45, all of the security functions judged to be necessary in the steps S41 and S45 are adopted as the required security functions (step S47). In this manner, all of the security functions judged to be necessary by the user or contents provider or based on the contents are adopted without exception to reflect all these policies. Depending on the situation, however, specific security functions maybe set as impossible to be carried out according to a particular criterion of the judgment. Thereafter, the control returns to the original processing.

Incidentally, although it is judged whether or not each of the filtering function, the saving function, the receipt acknowledgement function and the traceability function should be carried out in the processing described with reference to FIG. 5 and FIG. 6, the security levels shown in FIG. 3 may be determined in some cases.

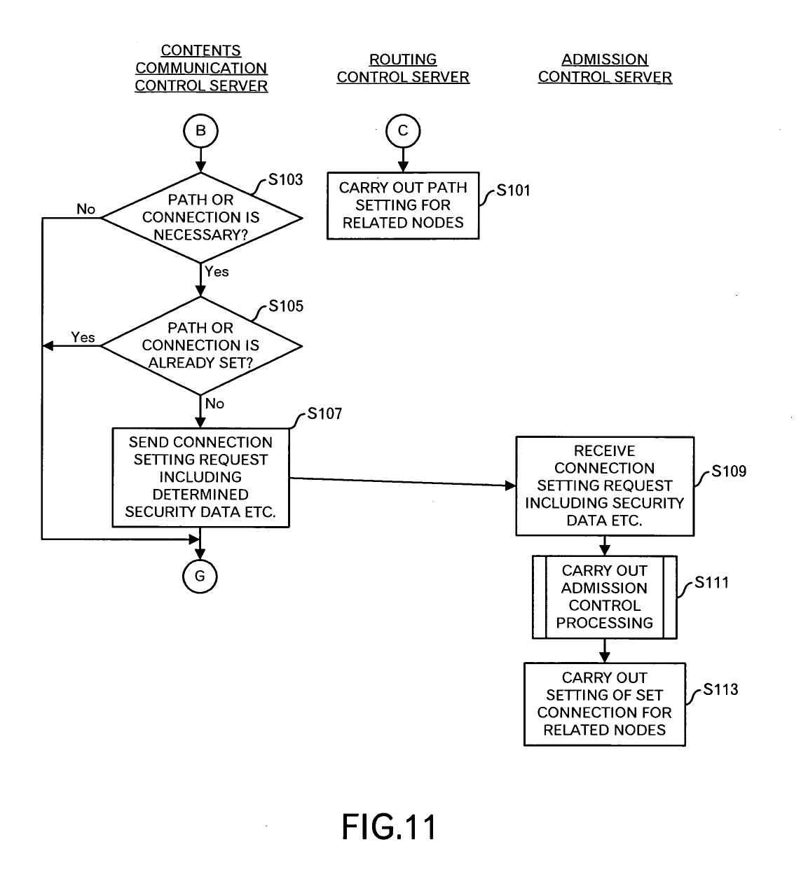

Returning to the description of FIG. 4, the contents communication control server 302 judges whether or not the path for use in transmitting the contents from the contents server 108 should be determined (step S11). In other words, it is judged whether or not the path has already been determined in another processing. If the path has already been determined in another processing, the control progresses to a processing in FIG. 11 via a terminal B. On the other hand, if the path is not determined yet and to be determined after this step, the contents communication control server 302 transmits a routing request including the data on security (i.e. security data (e.g. a security level or the security function to be carried out and the frequency of carrying out the designated processing and the like)), which was determined in the step S9, and the like to the routing control server 201 (step S13). The routing request includes, for example, the IDs or addresses of the edge router 105 (also referred to as a destination node) on the user terminal side and the edge router 106 (also referred to as a source node) on the contents server side and data on a required bandwidth and status data (abnormal or normal) contained in the access request or the like. The processing of the contents communication control server 302 progresses to the processing in FIG. 11 via the terminal B.

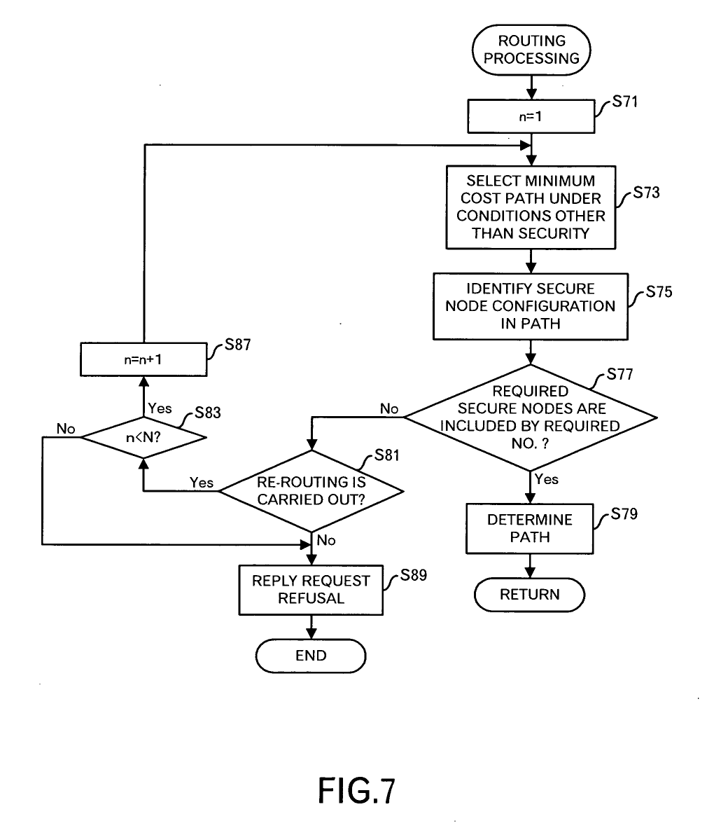

The routing control server 201 receives the routing request including the security data and the like from the contents communication control server 302, and stores it into a storage device such as a main memory (step S15). It then carries out a routing processing (step S17). This processing will be described with reference to FIG. 7 to FIG. 10. The processing progresses to the processing in FIG. 11 via a terminal C after the step S17. The routing control server 201 initializes n to 1, first (step S71). Thereafter, it selects the minimum cost path from the edge router 105 on the user terminal side to the edge router 106 on the contents server side under the conditions other than the security (step S73). This processing is the same as the conventional one and therefore it is not described anymore. It should be noted, however, that this processing is carried out by using data on a network configuration, which is not shown. The data on the network configuration includes data on whether or not the node is a secure node 104, data on the types of the security functions the secure node 104 has, and/or the like.

Subsequently, the routing control server 201 identifies the arrangement of the secure nodes 104 in the path identified in the step S73 (step S75). Specifically, it identifies the security functions the respective secure nodes 104 in the path have and how they are placed in the path (e.g. distance (i.e. the number of hops) and so forth). Thereafter, the routing control server 201 judges whether or not the necessary secure nodes 104 are contained by the required number or ratio thereof on the basis of the security data included in the routing request received from the contents communication control server 302 (step S77). For example, if it receives the security data that the traceability function should be arranged for every 3 hops, it judges whether or not the conditions defined in the security data are satisfied. Incidentally, when the required security functions are designated in the security data though the frequencies of carrying out the security functions are not designated, the conditions are determined to be satisfied only if there is at least one secure node 104 having the required security function in the path in one case. In another case, the minimum requirement for the frequency of carrying out the security function is predetermined, and it is judged whether or not the minimum requirement for the frequency is exceeded. Incidentally, when the network includes plural subnetworks and the path identified in the step S73 passes through the plural subnetworks, it is necessary to check the number of secure nodes 104 having the required security functions in each subnetwork or the rate of content of the secure nodes 104 in each subnetwork.

If it is judged that the required secure nodes 104 are contained by the required number or rate thereof, the routing control server 201 determines the path identified in the step S73 as a transmission path of the contents (step S79), and then the control returns to the original processing. Although the contents communication control server 302 is not notified of the determination of the path in the processing flow shown in FIG. 7, a path fixation message may be transmitted to the contents communication control server 302. In that case, the contents communication control server 302 may carry out the following processing after receiving the path fixation message.

On the other hand, unless it is judged that the required secure nodes 104 are contained by the required number or rate thereof, the routing control server 201 judges whether or not the re-routing should be carried out (step S81). Whether or not the re-routing should be carried out is determined based on the settings. Unless the re-routing is carried out, the routing control server 201 transmits a request refusal message to reject the routing request to the contents communication control server 302 (step S89). Upon receiving the request refusal message from the routing control server 201, the contents communication control server 302 returns a request refusal to the user terminal 101 via the edge router 105 on the user terminal side without carrying out the following processing, for example. The processing of the routing control server 201 is completed in this step.

On the other hand, if the re-routing should be carried out, the routing control server 201 judges whether or not n is less than a predetermined threshold N (step S83). If n is equal to or greater than the predetermined threshold N, the processing progresses to step S89 because the path cannot be identified though the routing is repeated N or more times. On the other hand, if n is less than the predetermined threshold N, n is incremented by one (step S87), assuming a path other than the current path identified in the step S73 as a new candidate, and then the control returns to the step S73. This embodiment describes a method of determining the minimum cost path in the step S73 after removing the maximum cost link in the previously selected path from the topology graph of the network as a method of extracting the new candidate for the path.

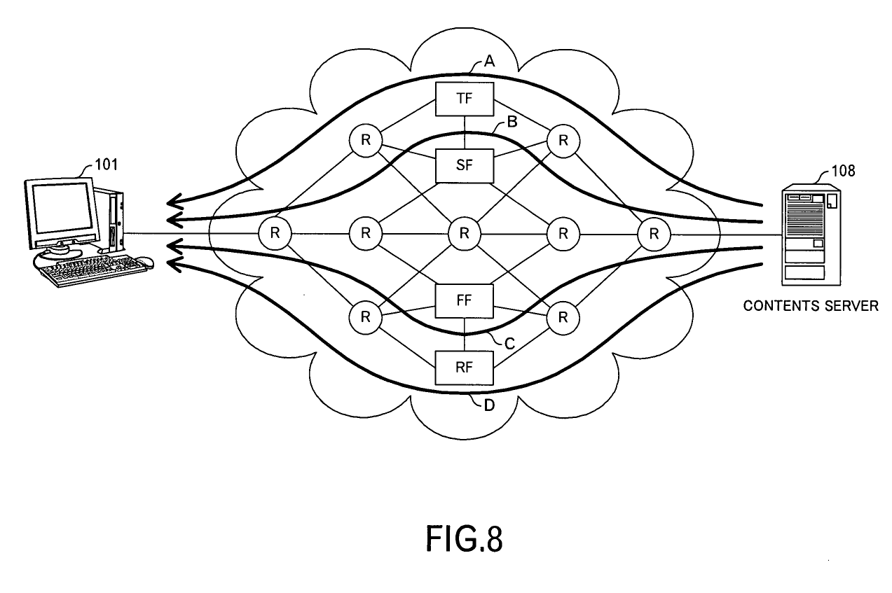

By carrying out such a processing, it becomes possible to carry out the processing of the required security functions to be carried out in the path, which are determined by the contents communication control server 302 at required frequencies. As shown in FIG. 8, when the contents communication control server 302 determines that the traceability function (TF) is necessary, the contents server 108 transmits the requested contents to the requesting user terminal 101 via a path A. In addition, when the contents communication control server 302 determines that the saving function (SF) is necessary, the contents server 108 transmits the requested contents to the requesting user terminal 101 via a path B. Furthermore, when the contents communication control server 302 determines that the filtering function (FF) is necessary, the contents server 108 transmits the requested contents to the requesting user terminal 101 via a path C. Similarly, when the contents communication control server 302 determines that the receipt acknowledgement function (RF) is necessary, the contents server 108 transmits the requested contents to the user terminal 101 via a path D.

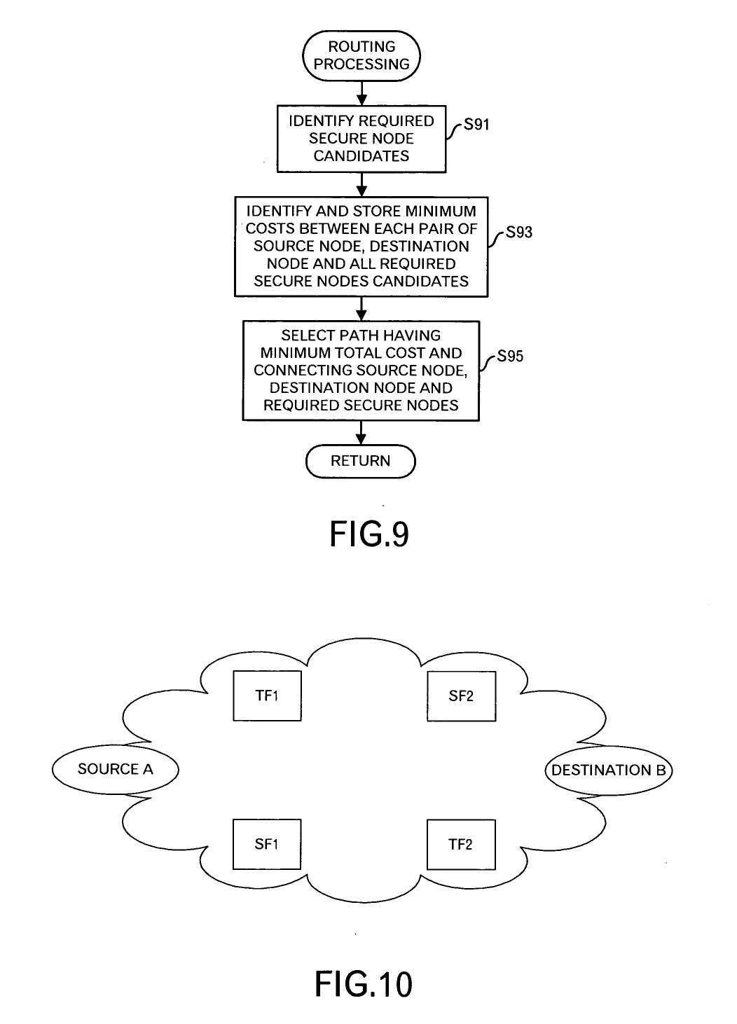

Subsequently, another processing flow of the routing will be described with reference to FIG. 9 and FIG. 10. The routing control server 201 identifies required secure node candidates based on the required security functions included in the security data received from the contents communication control server 302 and data on the network configuration (step S91). Specifically, it identifies the secure nodes 104 that the requested contents are likely to pass through from the edge router 105 on the user terminal side to the edge router 106 on the contents server side and that have the required security functions. For example, assuming that the required security functions are the traceability function (TF) and the saving function (SF) in the network as shown in FIG. 10, the routing control server 201 identifies TF1 and TF2 of the secure nodes 104 having the traceability function, and SF1 and SF2 of the secure nodes 104 having the saving function. Incidentally, here, A and B are assumed to be the source node and the destination node, respectively.

Thereafter, the routing control server 201 finds the minimum cost path between each pair of nodes: the source node (the edge router 106 on the contents server side), the destination node (the edge router 105 on the user terminal side), and all candidates for the secure nodes 104 having the required security functions. It then determines the cost values by using the data on the network configuration, and stores them in the storage device such as the main memory (step S93). In the step S93, when the required bandwidth or the like is designated, the routing control server 201 identifies the minimum cost path that satisfies the required bandwidth or the like.

Finally, the routing control server 201 determines the path candidates in such a way that the contents passes through the required number of secure nodes 104 (the number of secure nodes 104 satisfying the frequencies of carrying out the processing of the required security functions) having the required security functions from the source node to the destination node, calculates the total cost of each path candidate, and selects the path candidate having the minimum cost (step S95).

For example, the following path candidates are selected in the network as shown in FIG. 10:
A-TF1-SF1-B
A-TF1-SF2-B
A-TF2-SF1-B
A-TF2-SF2-B
A-SF1-TF1-B
A-SF1-TF2-B
A-SF2-TF1-B
A-SF2-TF2-B

For example, although FIG. 10 shows only the source and destination nodes and the secure node candidates having the required functions, it is assumed that there are nodes among them and plural paths connecting the source and destination nodes and the respective secure nodes. Among them, the routing control server 201 acquires the minimum cost path between the source node A and each secure node, first. It then acquires the minimum cost path between the secure nodes having different functions. Furthermore, it acquires the minimum cost path between each secure node and the destination node B. Finally, the routing control server 201 calculates the total cost for each of the a forementioned eight path candidates, which is the sum of the minimum costs of the relevant minimum cost paths, and selects a path whose total cost is the minimum.

Subsequently, a processing after the terminals B and C in FIG. 4 will be described with reference to FIG. 11 to FIG. 21. The routing control server 201 carries out path settings for the related nodes on the path when the path is determined in the step S17 (step S101). The routing control server 201 makes settings to deliver the specific contents, which is to be sent from the contents server 108 to the user terminal 101, along the path determined in the step S17 for the related nodes on the path. This processing is the same as the conventional one and therefore it is not described anymore.

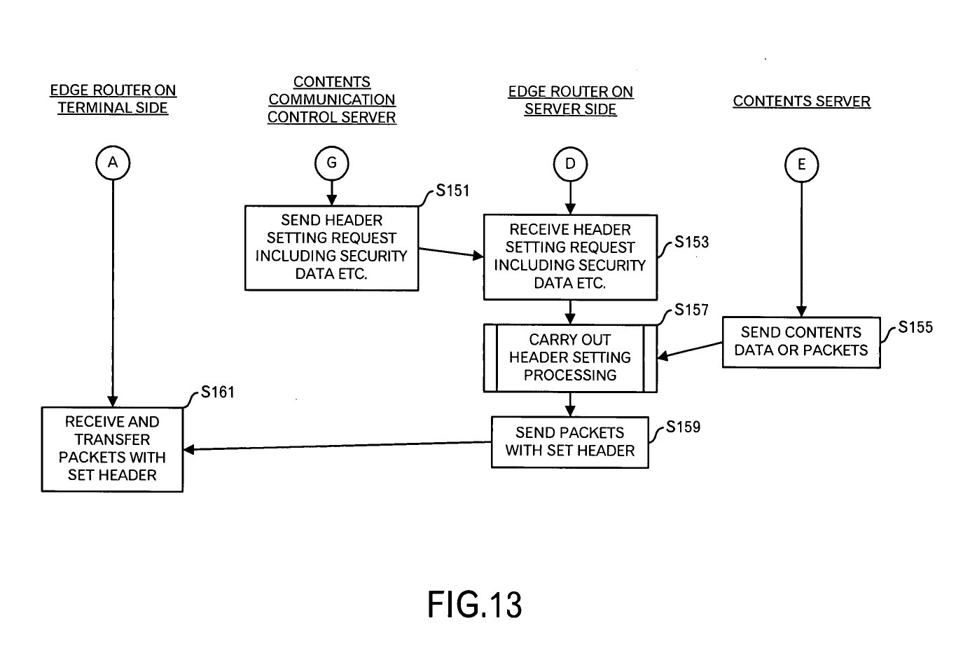

On the other hand, the contents communication control server 302 judges whether or not a path, connection, or the like is necessary (step S103). When the aforementioned routing processing has been carried out, there are certainly secure nodes 104 having the required security functions on the selected path. However, if a path has already been determined by another criterion in, for example, a server other than the routing control server 201, and a connection, path, session or the like is further required, it is uncertain whether the path (i.e. route) for the connection, path, session or the like contains the required number of secure nodes 104 having the required security functions. Therefore, it is necessary to add the judgment for such a condition in the admission control described below. In this embodiment, the path (i.e. route) has not been determined yet by the routing control server 201, and the contents communication control server 302 judges whether or not the path or the like should be set. When the setting of the path or the like is unnecessary, the control progresses to a processing in FIG. 13 via a terminal G.

On the other hand, when the setting of the path or the like is necessary, the contents communication control server 302 judges whether or not the path, connection, or the like has already been set by some means (step S105). If the path or the like has already been set by, for example, a server other than the admission control server 202, the control progresses to the processing in FIG. 13 via the terminal G. On the other hand, if the path or the like has not been set yet, the contents communication control server 302 transmits a connection setting request including data on the security (i.e. security data (e.g. a security level or the security function to be carried out and the frequency of carrying out the processing of the security function and so forth)) determined in the step S9 to the admission control server 202 (step S107). The connection setting request includes, for example, the IDs or addresses of the edge router 105 (also referred to as destination node) on the user terminal side and the edge router 106 (also referred to as source node) on the contents server side, and data on a required bandwidth and status data (abnormal or normal) contained in the access request or the like. The processing of the contents communication control server 302 progresses to the processing in FIG. 13 via the terminal G.

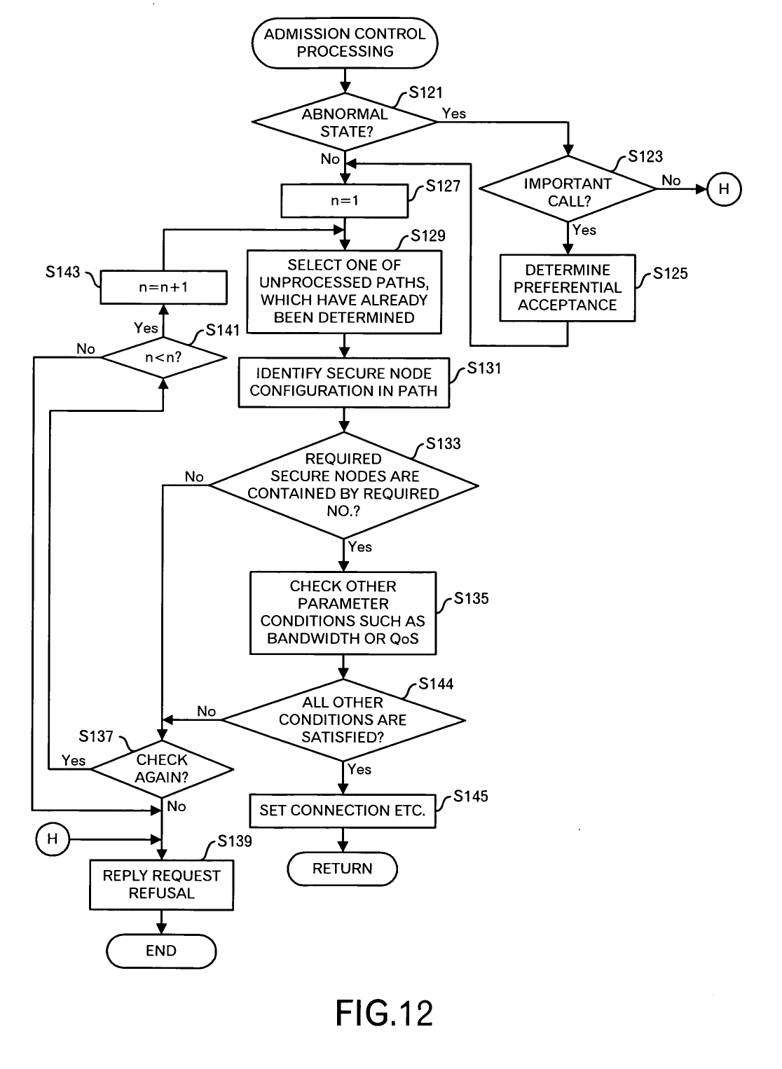

On the other hand, the admission control server 202 receives the connection setting request including the security data and the like from the contents communication control server 302 (step S109), and stores it in a storage device such as the main memory. Thereafter, it carries out the admission control processing (step S111). The admission control processing will be described with reference to FIG. 12.

The admission control server 202 judges whether or not the current status is abnormal, based on the status data included in the connection setting request (step S121). If the current status is abnormal, the admission control server 202 judges whether or not the access request related to the connection setting request is a predetermined important call (step S123). Whether or not it is important is determined based on whether or not the security level is set to “special” or whether or not the access destination is a particular place such as a police station.

It is the most important to prevent the communication of an important or emergency call from being interrupted at the time of the abnormal state. Therefore, if the access request related to the connection setting request is determined to be a predetermined important call, the admission control server 202 determines a preferential acceptance of the access request (step S125), then the control progresses to step S127. Incidentally, because it is necessary to accept the call to a maximum extent because of the preferential acceptance, it is also possible to set connection or the like in the path that has already been set, and then to return to the original processing, instead of the progressing to the step S127.

Unless the access request is determined to be an important call, the processing progresses to step S139 via a terminal H, and the admission control server 202 transmits a request refusal message to refuse the connection setting request to the contents communication control server 302. Upon receiving the request refusal message from the admission control server 202, the contents communication control server 302 transmits a request refusal to the user terminal 101, for example, via the edge router 105 on the user terminal side, without carrying out the processing described below. The processing of the admission control server 202 is completed in this step.

On the other hand, if the current status is determined to be normal in the step S121, the admission control server 202 initializes n to “1” (step S127). Thereafter, it selects one of unprocessed paths already determined by another criterion (step S129).

Subsequently, the admission control server 202 identifies the arrangement of the secure nodes 104 in the path selected in the step S129 (step S131). More specifically, it identifies security functions of the secure nodes 104 in the path and how they are placed in the path (e.g. distance (the number of hops) and so forth). Thereafter, the admission control server 202 judges whether or not necessary secure nodes 104 are contained by the required number or rate thereof, on the basis of the security data included in the connection setting request received from the contents communication control server 302 (step S133). For example, if it receives the security data that the traceability function should be set for every 3 hops, it determines whether or not a condition defined in the security data is satisfied. Incidentally, if the required security functions are designated in the security data though the frequencies of carrying out the security functions are not designated, the condition is determined to be satisfied only if there is at least one secure node 104 having the required security function in the path in one case. In another case, the minimum requirement for the frequency of carrying out the security function is predetermined and it is judged whether or not the minimum requirement for the frequency is exceeded. Incidentally, if the network includes plural subnetworks and the path selected in the step S129 passes through the plural subnetworks, it is necessary to check the number of secure nodes 104 having the required security functions in each subnetwork or the rate of the content of the secure nodes 104 in each subnetwork.

When it is determined that the required secure nodes 104 are contained by the required number or rate thereof, the admission control server 202 checks other parameter conditions such as a required bandwidth and a quality of service (QoS) included in the connection setting request regarding the path selected in the step S129 (step S135). This step is the same as the conventional one and therefore it is not described anymore. Thereafter, the admission control server 202 judges whether or not all other conditions are satisfied (step S144). Unless any other conditions are judged to be satisfied, the control progresses to step S137. On the other hand, when all other conditions are determined to be satisfied, the admission control server 202 sets the connection, session, path or the like by signaling onto the path selected in the step S129 (step S145).

On the other hand, unless it is determined that the necessary secure nodes 104 are contained by the required number or rate thereof or if any other conditions are not satisfied in the step S135, the admission control server 202 judges whether or not the path should be checked again (step S137). Whether the path should be checked again is judged based on the settings. Unless the path is checked again, the control progresses to the step S139.

On the other hand, if the path is checked again, the admission control server 202 judges whether n is less than a predetermined threshold N (step S141). If n is equal to or greater than the predetermined threshold N, it is assumed that the connection setting is not achieved though the routing is repeated N or more times and then the control progresses to the step S139. On the other hand, if n is less than the predetermined threshold N, n is incremented by one (step S143) and the control returns to the step S129.

Execution of this processing enables the admission processing, which includes checking on whether or not the required security functions are carried out at the required frequencies and setting the connection or the like.

Returning to the processing shown in FIG. 11, the admission control server 202 carries out settings for related nodes in order to achieve the connection set in the step S111 (step S113). This processing is the same as the conventional one and therefore it is not describe anymore. Thereafter, the control progresses to a processing after the terminal G.

The processing after the terminal G will be described with reference to FIG. 13 to FIG. 18. The contents communication control server 302 transmits a header setting request including security data and the like to the edge router 106 on the contents server side (step S151). Although this embodiment is an example of transmitting the header setting request to the edge router 106 on the contents server side, the header setting request may be transmitted to the contents server 108, and the contents server 108 may carry out the header setting processing described below. The edge router 106 on the contents server side receives the header setting request including the security data from the contents communication control server 302, and stores it into the storage device (step S153). On the other hand, the contents server 108 reads out the requested contents or packet data thereof from the contents database 109 in response to the access request received in the step S7 (FIG. 4) and transmits it to the edge router 106 on the contents server side (step S155). The edge router 106 on the contents server side receives the contents or packet data thereof from the contents server 108, and carries out a header setting processing (step S157). The header setting processing will be described in detail below. Thereafter, the edge router 106 on the contents server side transmits the packets or the like with a header set in the step S157 to the edge router 105 on the user terminal side (step S159). The packets or the like with the set header are transferred via routers (network devices) in the path described above. The edge router 105 on the user terminal side receives the packets or the like with the set header from the last router, and transfers them to the user terminal 101 (step S161). The user terminal 101 receives the packets or the like with the set header from the edge router 105 on the user terminal side, and displays them on a display device.

This enables the user terminal to receive the desired contents via the secure nodes 104 having the required security functions. The secure nodes 104 carries out the processing of the required security functions, thereby delivering the contents while ensuring the security as intended by the user, the contents provider, or the like and according to the attributes of the contents.

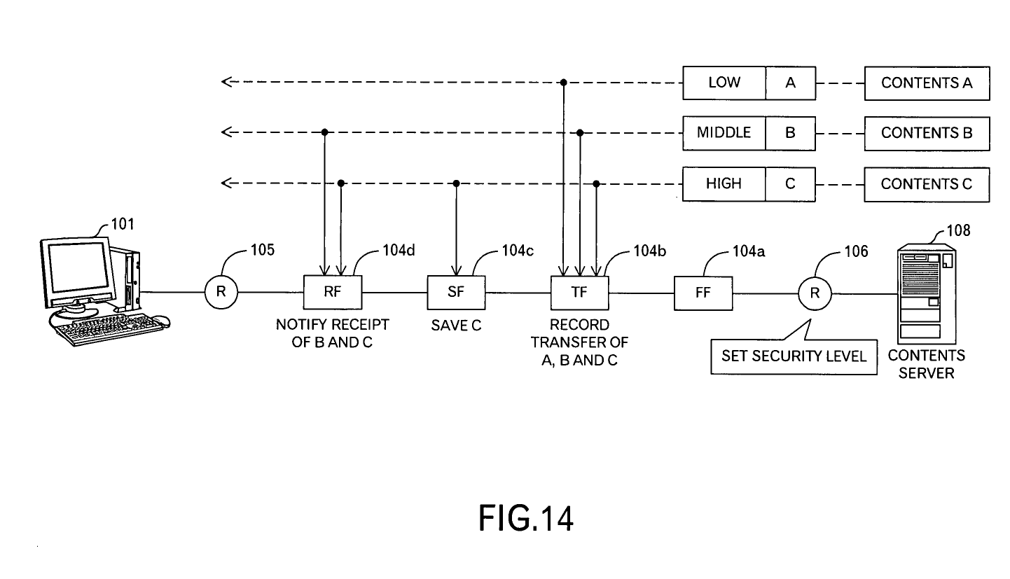

The following describes the header setting processing and its transfer processing carried out by the edge router 106 on the contents server side. First, a case where the security data includes a security level set according to the policy as shown in FIG. 3 will be described. Normally, the edge router 106 on the contents server side carries out a processing as shown in FIG. 14. First, when the security data includes the security level based on the policy as shown in FIG. 3, the edge router 106 on the contents server side sets the security level to the header, and adds it to data on the contents received from the contents server 108.

In the example shown in FIG. 14, the contents communication control server 302 determines that the security level is “low” regarding the contents A and notifies the edge router 106 on the contents server side of it, and therefore the edge router 106 on the contents server side sets the security level “low” to the header. In addition, regarding the contents B, the contents communication control server 302 determines that the security level is “middle” and notifies the edge router 106 on the contents server side of it, and therefore the edge router 106 on the contents server side sets “middle” to the header. Furthermore, regarding the contents C, the contents communication control server 302 determines that the security level is “high” and notifies the edge router 106 on the contents server side of it, and therefore the edge router 106 on the contents server side sets “high” to the header.

Thereby, the header analyzer 1041 of the secure nodes 104 on the path identifies the security functions to be carried out according to the policy shown in FIG. 3, and causes the retained security functions to carry out a processing of the security functions to be carried out, if necessary. Regarding the contents A having the header set to “low,” only the processing of the traceability function (TF) is to be carried out according to FIG. 3. Therefore, among a secure node 104a having the filtering function (FF), a secure node 104 having the traceability function (TF), a secure node 104c having the saving function (SF), and a secure node 104d having the receipt acknowledgement function (RF), only the secure node 104b having the traceability function (TF) operates to record the transfer of the contents A. For example, it records a date, the address of the user terminal 101, the address of the contents server 108, the ID (or URL) of the contents A, its own address or ID, and the like. Other routers carry out a simple transfer of the contents A, and the contents A are transmitted to the user terminal 101 via the edge router 105 on the user terminal side.

Regarding the contents B having the header set to “middle,” the processing of the traceability function (TF) and the receipt acknowledgement function (RF) is to be carried out according to FIG. 3. Therefore, the secure node 104b having the traceability function (TF) operates to record the transfer of the contents B. Furthermore, the secure node 104d having the receipt acknowledgement function (RF) operates to notify the transmission source of the receipt of the contents B. Other routers carry out a simple transfer of the contents B, and the contents B are transmitted to the user terminal 101 via the edge router 105 on the user terminal side.

Regarding the contents C having the header set to “high,” the processing of the traceability function (TF), the receipt acknowledgement function (RF), and the saving function (SF) is to be carried out according to FIG. 3. Therefore, the secure node 104b having the traceability function (TF) operates to record the transfer of the contents C. Furthermore, the secure node 104d having the receipt acknowledgement function (RF) operates to notify the transmission source of the receipt of the contents C. Still further, the secure node 104c having the saving function (SF) operates to save the contents C into the data storage.

In this manner, at the time of the normal state, the secure nodes 104 on the path carry out the required processing according to the security level. In addition, the combination of the security nodes 104 changes according to the security level.

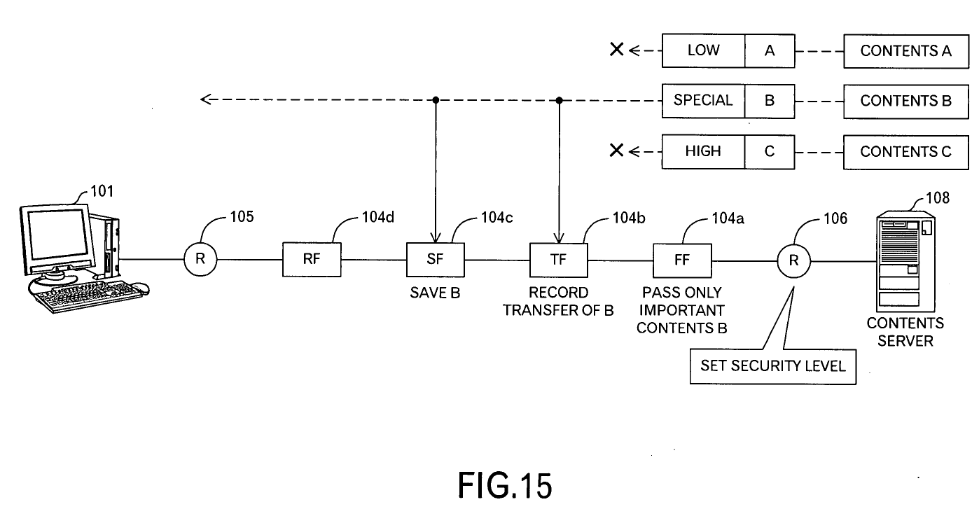

Moreover, at the time of the abnormal state, the processing as shown in FIG. 15 is carried out. As described above, the routing is carried out at the time of the abnormal state in such a way that the contents pass through the secure nodes 104 having the filtering function without fail.

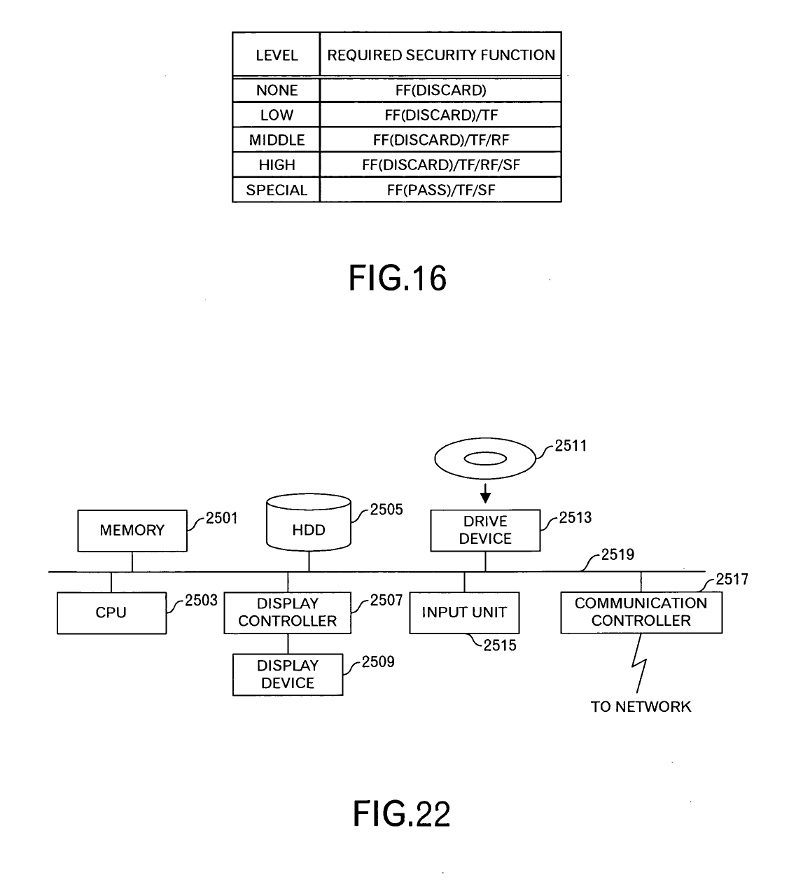

More specifically, the routing control server 201 sets the security levels based on the policy as shown in FIG. 16, which has been changed from the policy shown in FIG. 3. Specifically, the filtering function (which carries out discarding) is added to the required security functions in the range of the levels “none” to “high.” This causes the contents or packets thereof having the security level other than “special” to be discarded by the filtering function.

When a security level based on the policy as shown in FIG. 16 is included in the security data, the edge router 106 on the contents server side sets the security level to the header, and adds it to the data on the contents received from the contents server 108.

In this embodiment, “special” is set only for registered important contents or the like, and the normal levels are appended to other contents or the like.

Thus, regarding the contents B having the header set to the security level “special,” the secure node 104a having the filtering function (FF) passes it, the secure node 104b having the traceability function (TF) records the transfer of the contents B, and the secure node 104c having the saving function (SF) saves the contents B. Contents having the header set to one of other security levels are discarded by the secure node 104a having the filtering function (FF) that they reach without fail.

As described above, while the processing is the same between the abnormal state and the normal state in the edge router 106 on the contents server side, the combination of the secure nodes 104 on the path and their processing change according to the state.

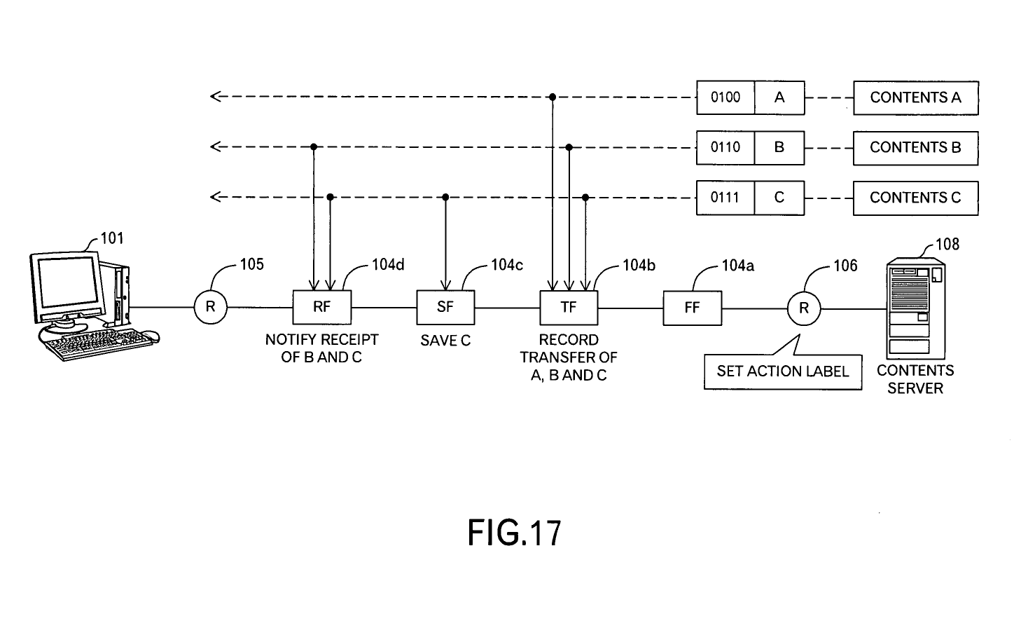

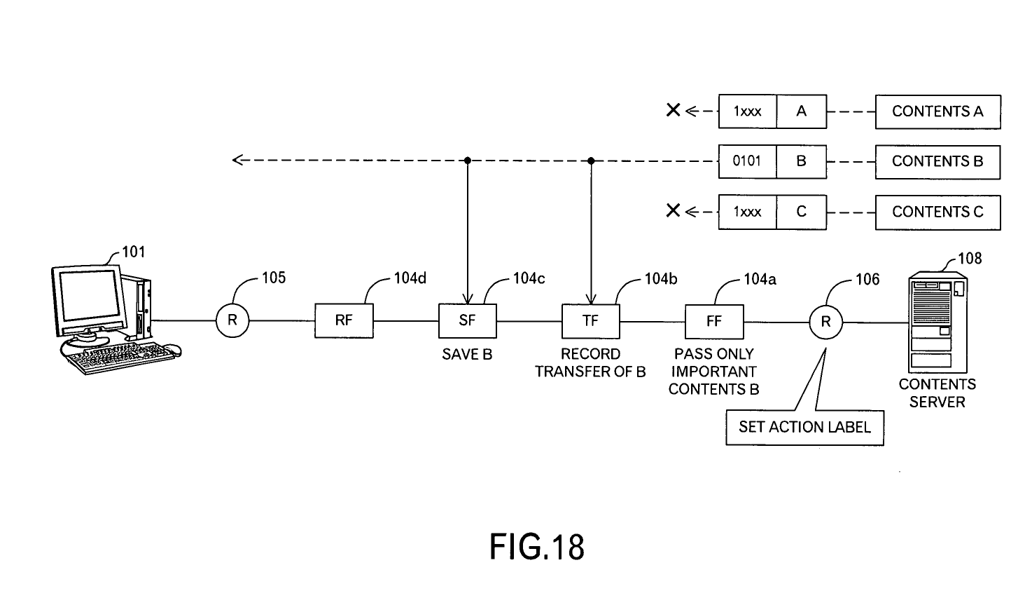

The following describes a case where the required security functions are explicitly designated in the security data, with reference to FIG. 17 and FIG. 18.

In this case, the edge router 106 on the contents server side converts the designation of the required security functions included in the security data in the header setting request received from the contents communication control server 302 to an action header, and then adds it to the data on the contents received from the contents server 108. More specifically, ON or OFF of the security function is represented by 1 bit. In a situation where the security functions are represented in the order of FF, TF, RF, and SF, the second bit from the left is set to “1” if the traceability function is designated, the third bit from the left is set to “1” if the receipt acknowledgement function is designated, and the fourth bit from the left is set to “1” if the saving function is designated. If the filtering function (which carries out passing) is designated or there is no designation of the filtering function, the leftmost bit is set to “0”. If the filtering function (which carries out discarding) is designated, the leftmost bit is set to “1”.

For example, when the security data includes the designation of the traceability function regarding the contents A, the action header is 0100, and the header analyzer of the secure node 104b having the traceability function (TF) interprets the action header, and then the traceability function records the transfer of the contents A.

Furthermore, when the security data includes the designations of the traceability function and the receipt acknowledgement function regarding the contents B, the action header is 0110. Therefore, the header analyzer of the secure node 104b having the traceability function (TF) interprets the action header, and then the traceability function records the transfer of the contents B. Furthermore, the header analyzer of the secure node 104d having the receipt acknowledgement function (RF) interprets the action header, and then the receipt acknowledgement function notifies the transmission source of the receipt of the contents B.

Still further, when the security data includes the designations of the traceability function, the receipt acknowledgement function, and the saving function regarding the contents C, the action header is 0111. Therefore, the header analyzer of the secure node 104b having the traceability function (TF) interprets the action header, and then the traceability function records the transfer of the contents C. The header analyzer of the secure node 104d having the receipt acknowledgement function (RF) interprets the action header, and then the receipt acknowledgement function notifies the transmission source of the receipt of the contents C. The header analyzer of the secure node 104c having the saving function (SF) interprets the action header, and then the saving function saves the contents C.

On the other hand, at the time of the abnormal state, the filtering function (which carries out passing) is designated only for the registered important contents or the like, and the filtering function (which carries out discarding) is designated for other contents or the like. Other security functions can be designated, but they need not always be designated.

As shown in FIG. 18, when the contents B are the registered important contents or the like, the filtering function (which carries out passing), the traceability function, and the saving function are designated, and thus the action header is 0101. Accordingly, the secure node 104a having the filtering function (FF) passes the contents B, the secure node 104b having the traceability function (TF) records the transfer of the contents B, and the secure node 104c having the saving function (SF) saves the contents B.

Other contents A and C are not registered important contents or the like, and therefore the filtering function (which carries out discarding) is designated for them to forcibly discard the contents A and C. Any designation is possible for other functions. Therefore, the action header is 1xxx (x can be either 0 or 1). Therefore, the secure node 104a having the filtering function (FF) discards the contents A and C.

As described above, while the setting of the action header is the same between the abnormal state and the normal state, the content of the action header is changed to switch the processing in each secure node 104.

Execution of the aforementioned processing enables the processing of the required security functions to be carried out at required frequencies, thereby enabling desired secure contents transmission.

As described hereinabove, the passage history of the contents is obtained when using the path in which the contents pass through the secure nodes having the traceability function. Furthermore, it is detectable how far the contents have flowed when a trouble occurs, and therefore it becomes easier to identify where the contents is missing. Still further, in the case of a leakage of confidential contents, the flow and destination can be confirmed. Moreover, if unwanted contents are detected, it is possible to seek out the source.

Moreover, when using a path in which the contents pass through a secure node having the saving function, the contents can be temporarily saved in the network. Therefore, when the contents are missing due to a network failure or the like, the network itself can retransmit the contents. Moreover, when plural users request the same contents, the saved contents can be used instead without transmitting the contents from the contents server, and therefore the saving function can be used as a cache function.

Furthermore, when using a path in which the contents pass through a secure node having the receipt acknowledgement function, the transmission destination can notify the transmission source of the receipt of the contents. Specifically, it prevents a trouble of determining whether or not the destination has received the information. In addition, the receipt acknowledgement function can give a trigger of deleting the contents that has been temporarily saved by the saving function.

Still further, when using a path in which the contents pass through a secure node having the filtering function, it is possible to forcibly pass or block the distribution of the contents. For example, it is possible to flow only important traffic at the time of the abnormal state such as a disaster.

The utilization of the secure nodes in this manner serves as a deterrent against computer-network crimes.

Furthermore, the utilization of the security functions embedded into the network devices has the advantages described below in comparison with guiding the contents or packets to a dedicated security server. Specifically, guiding to the server terminates the connection or session at the time once, by which the server needs to handle the protocol and it causes a delay. On the other hand, the secure node carries out the processing in the flow of transferring the contents or packets. Therefore, any unnecessary delay does not occur and the security functions are achieved while realizing the fast transfer of the contents or packets. Furthermore, a node containing the server needs to transmit the contents or packets twice for a transfer to the server and for transmission of an output from the server, while the secure node needs to pass the contents or packets only once. In addition, there is an advantage of preventing an increase in the total path length, which is caused by guiding to the server.

Incidentally, although the contents transmission have been described hereinabove assuming that the secure nodes are installed at dispersed locations in the network, the secure contents transmission is more effectively achieved by devising an appropriate layout of the secure nodes in the network.

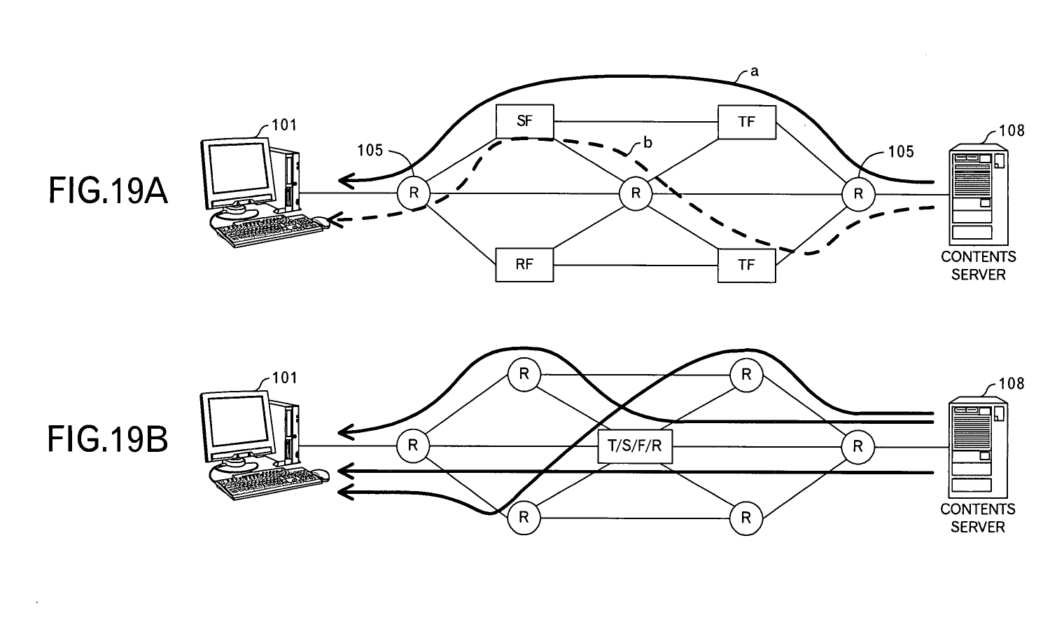

For example, when the saving function (SF) and the traceability function (TF) are identified as required security functions, the contents or packets are delivered from the edge router 106 on the contents server side to the edge router 105 on the user terminal side at the minimum cost of 3 hops, along a path a in the network configuration as shown in FIG. 19A. In other cases, however, for example, along a path b, the cost of 4 hops is required. Specifically, when the secure nodes have only a single function, the range of selections of the path is narrow.

On the other hand, when a secure node has plural functions (all security functions in FIG. 19B)) as shown in FIG. 19B, various paths can be adopted at the same cost, and thus a wider range of path selection is available, so that the network can be easily compliant with other constraints.

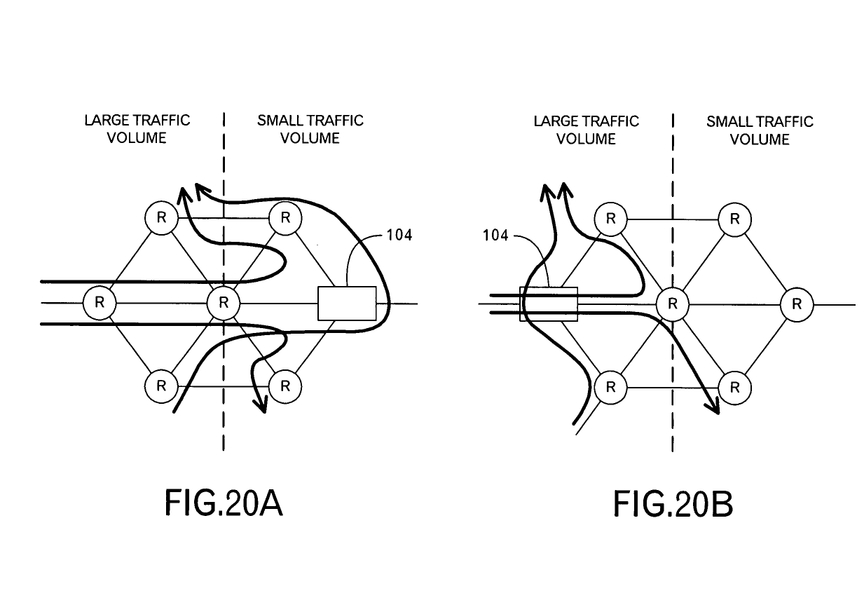

In addition, when the secure node 104 is placed in a location where the traffic volume is low in the network, the path is selected in such a way that the contents or packets pass through the secure node 104 represented by a square box as shown in FIG. 20A. The traffic from the left side where the traffic volume is high enters the secure node 104 on the right side where the traffic volume is low even if the traffic goes out from the left-side node. More specifically, the traffic passes through a node unnecessary under normal conditions, and therefore the path is often selected in such a way as to go a long way round, which leads to wasteful consumption of network resources. Then, on the assumption that Ai is the traffic volume generated by each node #i and Ni is the number of hops from the node #i to the secure node, the secure node is placed in the location to minimize the sum of consumed resources obtained by weighting the number of hops to the secure node by the traffic volumes, namely, the sum of the product of Ai and Ni. Thereby, the secure node 104 represented by the square box is placed at a branch point in the left area where the traffic volume is high as shown in FIG. 20B. This reduces the resource consumption, thereby achieving efficient routing.

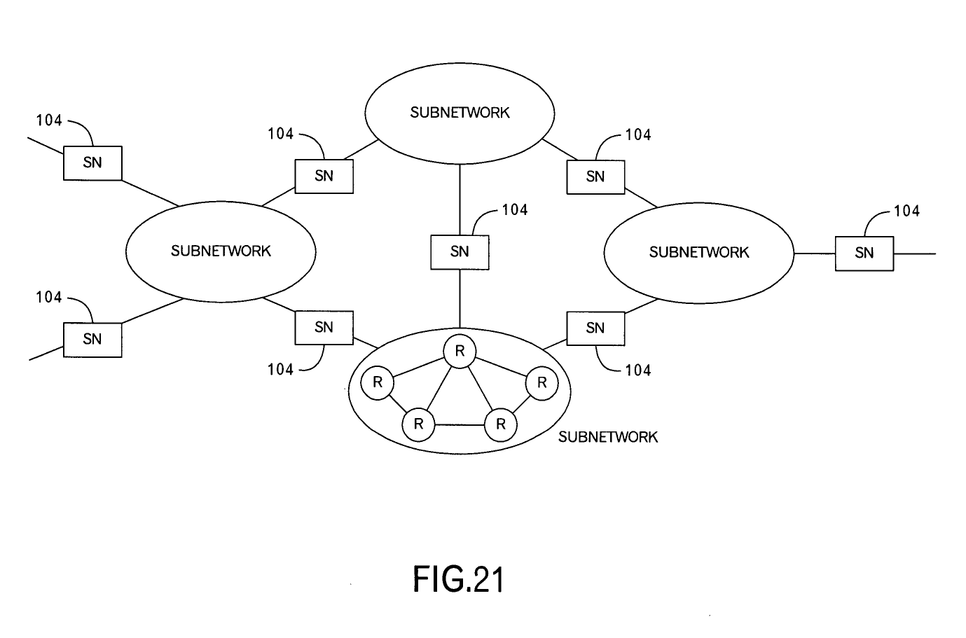

Furthermore, the Internet is a collection of networks referred to autonomous systems (AS), which are plural administrative units. In the wide area network that includes plural subnetworks as shown in FIG. 21, the setting of a path between subnetworks enables the secure routing as described above without fail, when using a secure node having all security functions as described above as the router to be a gateway between the subnetworks. In other words, there is no need to carry out the routing or to judge whether or not the condition of passing through a secure node having the required security functions is satisfied, in the routing control or the admission control.

While the preferred embodiment of the present invention has been described hereinabove, the present invention is not limited thereto. More specifically, while FIG. 1 shows a system having a three-layer structure as a system outline of the preferred embodiment, it is shown on a conceptual basis and therefore it does not always have to be the three-layer structure. In regard to the processing flows, it is not necessarily the case that the processing sequence described above need be maintained, but it is possible to alter the sequence or to carry out the processing in parallel when the results of processing are the same.

Incidentally, the status management server 301, the contents communication control server 302, the routing control server 201, admission control server 202, the transfer history management server 305, the contents server 108, the saving management server 307, and the user terminals 101 and 102 are computer devices as shown in FIG. 22. That is, a memory 2501 (storage device), a CPU 2503 (processor), a hard disk drive (HDD) 2505, a display controller 2507 connected to a display device 2509, a drive device 2513 for a removal disk 2511, an input device 2515, and a communication controller 2517 for connection with a network are connected through a bus 2519 as shown in FIG. 28. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removal disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application program are systematically cooperated with each other, so that various functions as described above in details are realized.

Although the present invention has been described with respect to a specific preferred embodiment thereof, various change and modifications may be suggested to one skilled in the art, and it is intended that the present invention encompass such changes and modifications as fall within the scope of the appended claims.

What is claimed is:

1. A communication control method for controlling communications in a network including a plurality of secure network devices having one or plurality of predetermined security functions, said communication control method comprising:
receiving a contents request for specific contents and a destination of said contents request; and
carrying out a routing by using, as routing conditions, security functions to be carried out in a transmission path of said specific contents from said destination of said contents request to a source of said contents request, and a quantitative condition of said secure. network devices each having said security function.

2. The communication control method as set forth in claim 1, wherein said quantitative condition of said secure network devices each having said security function to be carried out includes a quantitative condition in subnetworks included in said transmission path between said destination and said source of said contents request.

3. The communication control method as set forth in claim 1, wherein said secure network device has at least one of: a traceability function for recording history concerning establishment of a call, a connection, a path, or a session or history concerning passing of contents or packets; a saving function for saving the transferred contents or packets; a filtering function for controlling discarding or passing of said contents or packets; and a receipt acknowledgement function for notifying said source of receipt of said transferred contents or packets, as a security function.

4. The communication control method as set forth in claim 1, further comprising:
determining a security function to be carried out in said transmission path of said specific contents or a security level for identifying said security function, based on at least one of information concerning said source of said contents request, information concerning said destination of said contents request, and information concerning said specific contents.

5. The communication control method as set forth in claim 4, wherein said determining comprises:
identifying a security function to be carried out in said transmission path of said specific contents for each type of information designated to be used among said information concerning said source of said contents request, said information concerning said destination of said contents request, and said information concerning said specific contents; and
adopting all the identified security functions.

6. The communication control method as set forth in claim 4, further comprising:
switching a security function to be carried out in said transmission path of said specific contents at a time of a normal state and at a time of an abnormal state.

7. The communication control method as set forth in claim 4, further comprising: attaching a header corresponding to said security function to be carried out in said transmission path of said specific contents or said security level for identifying said security function, to the specific contents data or packets.

8. The communication control method as set forth in claim 6, wherein said switching comprises: reflecting a result of said switching to a header to be attached to the specific contents data or packets.

9. The communication control method as set forth in claim 7, wherein said header includes said security level, and
said communication control method further comprises:
by said secure network device having said security function in said transmission path, identifying a security function to be carried out based on said security level included in said header, and judging whether or not said security function said secure network has should be carried out.

10. The communication control method as set forth in claim 7, wherein said header includes an action label designating said security function to be carried out, and
said communication control method further comprises:
by said secure network device having said security function in said transmission path, identifying a security function to be carried out based on said action label included in said header, and judging whether or not said security function said secure network device has should be carried out.

11. The communication control method as set forth in claim 3, wherein said security functions to be carried out include said traceability function, and
said communication control method further comprises:
receiving transfer information of said specific contents from all said secure network devices having said traceability function in said transmission path, and storing the received transfer information into a history data storage in association with said specific contents.

12. The communication control method as set forth in claim 3, wherein said filtering function passes only designated important contents or packets at a time of an abnormal state.

13. The communication control method as set forth in claim 3, wherein said saving function stores designated important contents or packets at a time of an abnormal state.

14. The communication control method as set forth in claim 3, wherein said traceability function records said history concerning the establishment of a call, a connection, a path or a session or said history concerning the passing of said specific contents or packets at a time of an abnormal state.

15. The communication control method as set forth in claim 4, wherein said determining comprises: carrying out a mode switching based on status data including either a normal state or an abnormal state.

16. The communication control method as set forth in claim 7, wherein said determining comprises:
identifying a first security function to be carried out at a time of a normal state, or a first security level for identifying said security function to be carried out at the time of said normal state; and
identifying a second security function to be carried out at a time of an abnormal state, or a second security level for identifying said security function to be carried out at the time of said abnormal state, and
said attaching comprises:
attaching a header corresponding to the identified first security function or the identified first security level to said specific contents data or packets; and
attaching a header corresponding to the identified second security function or the identified second security level to said specific contents data or packets.

17. The communication control method as set forth in claim 1, wherein said carrying comprises: identifying a transmission path candidate whose total cost is the minimum among a plurality of transmission path candidates of said specific contents from said destination of said contents request to said source of said contents request.

18. The communication control method as set forth in claim 1, wherein said quantitative condition of said secure network devices each having said security function is defined by a rate for a number of hops along said transmission path.

19. The communication control method as set forth in claim 2, wherein said quantitative condition in said subnetwork is defined by a number or a rate of said secure network devices in each said subnetwork.

20. A network, comprising:
a plurality of secure network devices, each having at least one security function; and
a unit that carries out a routing by using, as routing conditions, security functions to be carried out in a transmission path of specific contents from a destination of a contents request for said specific contents to a source of said contents request, and a quantitative condition of said secure network devices each having said security function.

21. The network as set forth in claim 20, further comprising:
a unit that determines a security function to be carried out in said transmission path of said specific contents or a security level for identifying said security function, based on at least one of information concerning said source of said contents request, information concerning said destination of said contents request, and information concerning said specific contents.

22. A network, comprising:
a plurality of secure network devices, each having at least one of a traceability function for recording history concerning establishment of a call, a connection, a path, or a session or history concerning passing of contents or packets, a saving function for saving the transferred contents or packets, a filtering function for controlling discarding or passing of said contents or packets, and a receipt acknowledgement function for notifying a transmission source of the transferred contents of receipt of said transferred contents, as security functions, and
wherein said secure network devices are arranged at positions that are calculated based on a traffic demand and a number of hops or a distance and minimizes resource consumption caused when passing through said secure network devices.

23. A network, comprising:
a plurality of secure network devices, each having at least one of a traceability function for recording history of a call, a connection, a path, or a session or history concerning passing of contents or packets, a saving function for saving the transferred contents or packets, a filtering function for controlling discarding or passing of said contents or packets, and a receipt acknowledgement function for notifying a transmission source of said transferred contents of receipt of said transferred contents as security functions, and
wherein said secure network devices are arranged at a boundary of subnetworks in a wide area network.

24. A communication control method for controlling communications in a network including a plurality of secure network devices having one or plurality of predetermined security functions, said communication control method comprising:
receiving a contents request for specific contents and a destination of said contents request; and
determining a security function to be carried out by said secure network device in a transmission path of said specific contents or a security level for identifying said security function based on at least one of a source of the received contents request, said destination of the received contents request, and said specific contents.

25. The communication control method as set forth in claim 24, further comprising:
determining said transmission path of said specific contents irrespectively of said security function to be carried out or said security level; and
judging whether or not a connection, a path or a session, which is established on the determined transmission path, includes all of said security functions to be carried out and satisfies a quantitative condition of said secure network devices having said security functions to be carried out.

26. The communication control method as set forth in claim 25, further comprising:
rejecting said contents request, upon a negative judgment in said judging.

27. The communication control method as set forth in claim 26, further comprising:
carrying out said determining and said judging again upon a negative judgment in said judging.

28. A communication control apparatus for controlling communications in a network including a plurality of secure network devices having one or plurality of predetermined security functions, said communication control apparatus comprising:
a unit that receives a contents request for specific contents and a destination of said contents request; and
a unit that determines a security function to be carried out by said secure network device in a transmission path of said specific contents or a security level for identifying said security function based on at least one of a source of the received contents request, said destination of the received contents request, and said specific contents.

29. A communication control apparatus for controlling communications in a network including a plurality of secure network devices having one or plurality of predetermined security functions, said communication control apparatus comprising:
a unit that receives a contents request for specific contents and a destination of the contents request; and
a unit that carries out a routing by using, as routing conditions, security functions to be carried out in a transmission path of said specific contents from said destination of said contents request to a source of said contents request, and a quantitative condition of said secure network devices each having said security function.

30. A network device, comprising:
a unit that receives data concerning a security function to be carried out in a transmission path of specific contents for a contents request for said specific contents or data concerning a security level for identifying said security function to be carried out from a communication control apparatus; and
a unit that attaches a header corresponding to said security function to be carried out in said transmission path of said specific contents or said security level for identifying said security function, to the specific contents data or packets.

31. A secure network device, comprising:
a security function including at least one of: a traceability function for recording history concerning establishment of a call, a connection, a path, or a session or history concerning passing of contents or packets, a saving function for saving the transferred contents or packets, a filtering function for controlling discarding or passing of said contents or packets, and a receipt acknowledgement function for notifying a source transmission of said transferred contents of receipt of said transferred contents or packets, as a security function;
a unit that receives data or packets of specific contents, which has a header corresponding to a security function to be carried out in a transmission path of said specific contents for a contents request for said specific contents or to a security level for identifying said security function to be carried out; and
a unit that identifies a security function to be carried out based on said security level included in said header if said header includes said security level, and judges whether or not said security function said secure network device has should be carried out.

32. A secure network device, comprising:
a security function including at least one of: a traceability function for recording history concerning establishment of a call, a connection, a path, or a session or history concerning passing of contents or packets, a saving function for saving the transferred contents or packets, a filtering function for controlling discarding or passing of said contents or packets, and a receipt acknowledgement function for notifying a source transmission of said transferred contents of receipt of said transferred contents or packets, as a security function;
a unit that receives data or packets of specific contents, which has a header corresponding to a security function to be carried out in a transmission path of said specific contents for a contents request for said specific contents or to a security level for identifying said security function to be carried out; and
a unit that identifies said security function to be carried out based on an action label included in said header if said header includes said action label designating said security function to be carried out, and judges whether or not said security function said secure network device has should be carried out.
